(19) United States
(12) Patent Application Publication
(10) Pub. No.: US 2006/0147348 A1
(43) Pub. Date: Jul. 6, 2006

(54) Sampling device and methods

(76) Inventor: Greg Liang, Rancho Cucamonga, CA (US)

Correspondence Address: BIOTECHNOLOGY LAW GROUP;C/O PORTFOLIOIP, PO BOX 52050, MINNEAPOLIS, MN, 55402, US

(21) Appl. No.: 11/271,179

(22) Filed: Nov. 12, 2005

Related U.S. Application Data
(60) Provisional application No. 60/627,732, filed on Nov. 13, 2004.

(51) Int. Cl. B01L 3/00

(52) U.S. Cl. 422/99

(57) ABSTRACT

Provided herein are methods of testing mucus for the presence of analytes, for example, drug analytes, and devices, kits, and methods for collecting test mucus samples.

Priority is claimed to U.S. provisional patent application Ser. No. 60/627,732, filed 13 Nov. 2004 by Greg Liang, and entitled “Sampling Device and Methods,” which is referred to and incorporated herein by reference in its entirety.

### FIELD OF THE INVENTION

The present invention is related to the collection of bodily fluid samples and testing for diagnostic purposes, for example, to the collection of oral fluid samples for diagnostic and drug testing.

### BACKGROUND

Detecting analytes in oral fluids for the diagnosis of diseases is playing an increasingly important role in diagnostics. Because of the convenience and the non-invasive nature of sampling oral fluid, oral fluid testing is also useful for point-of-care tests for drug analytes such as abused or illegal drugs, or therapeutic drugs.

Available oral fluid sampling methods are mainly for acquiring saliva from the mouth. These include aspiration, expectoration, and absorption with absorption paper or sponges. These samples are usually collected by placing the collection material under the tongue or on the sides of the tongue in the cheek areas, where saliva resides. Although many soluble analytes, such as antibodies, enzymes, or some drugs, can be consistently detected in saliva, some analytes are unevenly distributed in various oral fluids. For example, a significant amount of orally ingested drugs may be sequestered in the oral cavities for a period of time. Sequestered drugs are likely to be present in mucus and other fluids that are already present in the mouth at the time the drugs were ingested other than in freshly secreted saliva. Saliva in the mouth is replaced by newly secreted saliva every a few minutes, thus, the amount of a drug present in freshly secreted saliva is usually the portion secreted from blood to saliva only.

An example of a method collection of samples from the mouth for drug testing includes the DrugWipe device, which can be used to test saliva after an individual spits into a tube, or which has an absorbent surface that can be wiped directly on the tongue of a test individual. (Pichini, S., et al., Clinical Chemistry 48 (1) 174-176 (2002); Samyn, N., and van Haeren, C., International Journal of Legal Medicine 113 (3): 150-154 (2000); Navarro, M., et al., TIAFT Young Scientists Workshop 2001 (Apr. 6-7, 2001, Gent, Belgium)) Additional information on the DrugWipe system may be found, for example, on the worldwide web at securetec.net/cms/front_content.php?idcat=36&changelang=2&client=1.

There is a need for a reliable method of detecting analytes, for example drugs, in the mouth, that can be used for a practical period of time after ingestion of the drug.

### SUMMARY OF THE INVENTION

Accordingly, it has been found that certain drug analytes may be more reliably tested for a longer period of time after ingestion, by assaying for these analytes in mucus collected from mucosal surfaces of the mouth of an individual. Therefore, in a first embodiment is provided a method for detecting a drug analyte in the mouth of an individual, comprising collecting mucus off of a mucosal surface area of the mouth of an individual; and testing said mucus for the presence of said drug analyte. The mucus may be collected, for example, using a non-absorbent collection material, which may, for example, have a scraping edge. The mucus may be collected by scraping a mucosal surface area. By collecting the sample using a non-absorbent material, more mucus, and less saliva, is collected than when collecting using an absorbent material. The mucosal surface area of the mouth may include, for example, the inside of a cheek, the roof of the mouth, the inside of the chin, or, in an illustrative example, the tongue. The non-absorbent collection material may, for example, be a plastic card, a non-absorbent scraping edge, a wire mesh, or the like. In some embodiments the non-absorbent collection material is connected to a void for mucus collection. In some embodiments, the void is in fluid communication with a mucus reservoir.

By “individual” is meant any animal, for example, a mammal, such as, for example, a human, horse, monkey, ape, bovine, rodent, or domestic animal. The individual may be, for example, a human. In an illustrative example, the human is suspected of having ingested a drug, or has ingested a drug, such as, for example marijuana.

The analyte tested may be, for example, any analyte that is likely to be sequestered in mucus, such as, for example, a hydrophobic analyte. The analyte may be, for example, a legal, therapeutic, or illegal drug analyte, or a poison, ingested orally, via injection, or other routes. The drug analyte may be, for example, a benzodiazepine, or a metabolite thereof. The drug analyte may, in an illustrative example, be Tetrahydrocannabinol (THC).

In another embodiment of the present invention is provided a composition comprising mucus and an additive such as, for example, a pH buffer, a solvent for hydrophobic substances, a detergent, a preservative, an enzyme, or an antibody capable of reacting with the analyte substance. For example, for an enzyme linked immunosorbent assay (ELISA) for detecting THC, the composition may be a buffer solution containing a horseradish peroxidase (HRP) labeled mouse anti-THC antibody. When a mucus specimen containing THC is mixed with the composition, a portion of the HRP-THC antibody binds to the THC in the specimen. The reaction mixture is further transferred to a reaction well containing immobilized THC-bovine serum albumin (BSA) conjugate, which will bind the unbound portion of HRP-THC antibody. The portion of the HRP-THC bound to the reaction well, which detectable using a HRP substrate system is reversely related to the amount of THC in the mucus specimen. The composition may contain a solvent such as methanol alcohol, dimethylformamide (DMF), dimethyl sulfoxide (DMSO), which is capable of increasing the solubility of THC. The composition may contain a preservative, such as sodium azide, antibiotic, or ethanol alcohol. The mucus may, for example, be obtained by scraping a mucosal surface area of the mouth of an individual, such as, for example, the tongue.

In yet another embodiment of the present invention is provided a device for collecting a mucus specimen from a mucosal surface area of the mouth of an individual, comprising a handle having a first end and a second end, a specimen collection section disposed toward or releasably secured to the first end of said handle, wherein said specimen collection section has a non-absorptive scraping edge, and a void adjacent to said scraping edge for containing a volume of mucus. The scraping edge may, for example, be sharp enough to collect mucus, but not sharp enough to cause injury to, or cut, the individual. In some embodiments, the specimen collection section and said handle are releasably secured. In some embodiments, the void is a slotted groove having two walls. The angle between the two walls of the groove may be, for example, about 75 to about 150 degrees, or for example, about 90 to about 120 degrees, or, for example, from about 100 to about 110 degrees. In some embodiments, the void is a receptacle for mucus, and may, for example, be in fluid communication with a mucus reservoir. The reservoir may, for example, be attached to the handle. In an illustrative embodiment, the reservoir is removably attached to the handle. In yet other embodiments, the reservoir may be disposed in a vacuum line connecting the scraping edge and a vacuum source, and may, for example, be removably attached to said vacuum line.

Embodiments of the invention also include an assay system for the detection of at least one drug analyte in the mouth, comprising a device of the invention and an assay component capable of enabling a diagnostic testing procedure for the detection of the drug analyte in the mucus specimen. The diagnostic procedure may be, for example, selected from the group consisting of high performance liquid chromatography, gas chromatography/mass spectrometry, liquid chromatography, capillary electrophoresis, and immunoassay. The assay component may, for example, be selected from the group consisting of a pH buffer, a solvent for hydrophobic substances, a detergent, a preservative, and enzyme, and an antibody capable of reacting with the analyte substance.

Also provided in the present invention is a kit comprising a device of the present invention, an assay component capable of enabling a diagnostic testing procedure for the detection of the drug analyte in the mucus specimen, and instructions on the use of the kit. In yet another embodiment is a method for collecting a mucus specimen from a mucosal surface area of the mouth of an individual, comprising scraping a mucosal surface area of the mouth of an individual with the non-absorbent scraping edge of a device of the present invention.

### BRIEF DESCRIPTION OF THE DRAWINGS

FIG. 1 is a perspective view of a device of an embodiment of the invention.

FIG. 2 is a perspective view of a device of an embodiment of the invention.

FIG. 3 is an exploded view of the same device of FIG. 2.

FIG. 4 is a perspective view of a device of an embodiment of the invention.

FIG. 5 is a perspective view of a device of an embodiment of the invention.

FIG. 6 is a sectional view of the device of FIG. 5.

### DETAILED DESCRIPTION OF THE INVENTION

An advantage of testing the mucus specimen is that some drug analytes are present in higher concentration in the mucus of the mucosa surfaces than in saliva; collecting and testing mucus results in higher assay sensitivity of the method for the detection of these analytes than testing saliva. The non-absorptive nature of the scraping edge results in a high volume of mucus specimen to be scraped off the mucosa surface and be received by the specimen receptacle. The device and methods are especially useful for point of collection (POC) sample collection and testing of drugs in the mouth.

The methods of the present invention are useful for testing for any analyte present in the mucus of the mucosal surface areas of the mouth. The methods are especially useful for those analytes that are present in higher concentration in the mucus than in saliva. Drug analytes that are present in higher concentration in the mucus than in saliva include more hydrophobic drug analytes, such as, for example, THC. THC present in the mouth is usually from oral ingestion, smoking, or eating. Another category of drugs, benzodiazepines, are very difficult to detect in saliva, they are relatively hydrophobic. Thus, another example of a hydrophobic drug analyte is a benzodiazepine. Some benzodiazepines are very hydrophobic and tend to bind to macromolecules and surface areas, such as alprozolam and triazolam. Hydrophobic Benzodiazepines sequestered in the mouth due to oral ingestion of the drugs present in mucus at higher concentration than in saliva. Benzodiazepines are known to those of ordinary skill in the art, some representative embodiments may be found listed in, for example, Benzodiazepines—A Medical Dictionary, Bibliography, and Annotated Research Guide to Internet References (2004, Icon Health Publications).

One aspect of the invention is a device for collecting a mucus specimen from the mouth cavities. The mucus sampling device includes a handle elongated by a specimen collection section having a non-absorptive scraping edge capable of scraping a volume of mucus off a mucosa surface of the mouth and a specimen receptacle in fluid connection with the non-absorptive scraping edge and is capable of receiving a portion of the mucus scraped off the mucosa surface of the mouth. In some embodiments, the handle may be made of an inert material, for example, plastic, rubber, metal, and the like. In an illustrative embodiment, the handle is made of a plastic by injection molding. In an embodiment, for the convenience of specimen collection, the length of the handle may be about 3 inches to about 10 inches, or, for example, 4 inches to about 9 inches, or, for example, 4 inches to about 8 inches, or, for example, 4 inches to about 8 inches, or, for example, 4 inches to about 7 inches, or, for example, 5 inches to about 7 inches, or, for example, 5 inches to about 6 inches. The thickness of the handle is sufficient to satisfy its stiffness required for handling of the device and for specimen collection. The handle may, for example, have a diameter about the size of a chopstick, for example, a disposable chopstick. The handle may, for example have a diameter of about 2 mm to about 12 mm, or for example, of about 3 mm to about 10 mm, or, for example, of about 3 mm to about 9 mm, or, for example, of about 3 mm to about 8 mm, or, for example, of about 3 mm to about 6 mm, or, for example, of about 4 mm to about 6 mm, or, for example, of about 4 mm to about 5 mm.

In an embodiment, the specimen collection section is removably connected to the handle. In one embodiment of the device of the invention, the specimen collection section and the handle are molded in the same plastic part having a weak point or break-line between the two sections from where the two sections can be separated. In another embodiment of the invention, the specimen collection section and the handle are separate parts that are removably connected. The reversible connection between the specimen collection section and the handle may be, for example, snug fitting, locking, or bonding, The two connected parts may be separated, for example, by pulling, bending, unlocking, and tearing. Having a removable connection allows for convenient sample treatment and analyte extraction, as well as convenient sample transportation and storage. In one example, the specimen collection section may be separated from the handle and placed in a container, for example, a vial. The vial may, for example, contain test buffer or preservative buffer. In one embodiment, the vial containing the specimen collection section may be forwarded to a laboratory for testing, or may be tested on site. In an embodiment, the vial has a dropper cap, and the liquid contained by the specimen collection section may be squeezed out of the dropper hole of the cap for testing.

The non-absorptive scraping edge is nay be, for example, in the shape of a straight or curved line and is sharp enough for scraping a volume of mucus off a mucosa surface of the mouth without causing injury of the mouth. The length of the scraping edge may be about 0.5 inches to about 2 inches, or, for example, about 1 to about 2 inches. The specimen collection section may be elongated and disposed in the direction that is substantially perpendicular to the length of the handle. The non-absorbent edge of the specimen collection section may be disposed in a similar orientation, at the opposing side to the attachment to the handle. The non-absorbent edge may run substantially along the length of the specimen collection section. The non-absorbent edge may be sufficiently sharp to scrape mucus off of a mucosal surface, such as, for example, the tongue, and not be so sharp as to cause injury to the mucosal surface. For example, the edge may range from a 90 degree angle to about a 150 degree angle, to a smooth round edge, to a sharper angle about the sharpness, or radius of the edge of a butter knife. Those of skill in the art will understand that less pressure need be applied while scraping where the device has a sharper edge. The non-absorbent edge may be bent downward from the handle, or it may be disposed along the same plane as the handle.

The specimen collection section is essentially composed of an inert material, for example, plastic, rubber, or metal. In an illustrative embodiment, the section is made of a plastic by injection molding. If the primary portion of the specimen collection section is made of a soft material, such as a rubbery material, the non-abrasive scraping edge may, for example, be made of a stiff material, such as a plastic or a metal. The specimen collection section is typically inserted into the specimen donor's mouth when the specimen is collected, thereby, the shape of the section is, for example, donor friendly without sharp comers and edges that may potentially cause injury of the specimen donor. The size of the specimen collection section is sufficient to connect the scraping edge and the handle and small enough for being easily inserted into the specimen donor's mouth.

The specimen receptacle is a void structure in fluid connection with the non-absorptive scraping edge, thus the specimen receptacle, or void, is capable of receiving a portion of mucus scraped off a mucosa surface of the mouth by the non-absorptive scraping edge. The void may be adjacent to the scraping edge or in fluid communication with the scraping edge. In some embodiments, the specimen receptacle is a reservoir that may, for example, be removably attached to the handle or other portion of the device, allowing it to be removed from the device and transferred to another location for storage or analysis of the mucus sample. The absorptive property, shape, and position in the device of the reservoir may vary depending on different embodiments of the device. In one embodiment, the reservoir may be disposed in a vacuum line connecting the scraping edge and a vacuum source.

The method for collecting a mucus specimen from the mouth of the invention comprises scraping a volume of mucus off a surface of the mouth by holding and moving the handle of the device of the invention and receiving a portion of the scraped mucus at the specimen receptacle.

FIG. 1 depicts an embodiment of the device of the invention (100) comprising a handle (110) elongated by a specimen collection section (120) having a non-absorbent scraping edge (121) and a non-absorptive specimen receptacle (122) adjacent to the non-absorbent scraping edge (121). The non-absorptive specimen receptacle (122) comprises primarily a non-absorptive surface area capable of adsorbing a volume of mucus scraped from a mucosa surface of the mouth due mainly to the stickiness of the mucus specimen to the non-absorptive surface area. The non-absorptive surface area of the non-absorptive specimen receptacle (122) may be, for example, of an inert material capable of adsorbing mucus from the mouth, such as plastic, rubber, and metal, and the like, and, in an illustrative embodiment is made of a plastic material by injection molding. The non-absorptive specimen receptacle may be, for example, made of the same material in the same part as the non-absorptive scraping edge (121). When the non-absorbent scraping edge (121) is rubbed against a surface of the mouth cavity by an operator holding and moving the handle (110) of the device, a volume of mucus is capable of being scraped off the mucosal surface and a portion of the scraped mucus is capable of being received by the specimen receptacle (122). The non-absorptive surface receptacle (122) may, for example, comprise a groove (123), which provides a space between the mucosa surface and the surface of the specimen receptacle for containing the scraped specimen. The mucus specimen adhered to the surface area of the groove (123) will tend to reside in the groove (123).

The mucus specimen collected using a device (100) comprising a non-absorptive surface specimen receptacle (122) can be transferred to an assay device for analysis or to a container until it is tested. The specimen may either be allowed to drip off the specimen receptacle from one end of the elongate specimen receptacle by tilting the device until the specimen receptacle is substantially in a vertical position. Another way to collect the specimen off the non-absorbent specimen receptacle is to scrape the mucus specimen or absorb the specimen with an absorbent material. Another method to store the specimen collected using the device (100) is to store the collection section (120) or the entire device (100) in a container. The device (100) may, for example, include a break-line (130) between the handle (110) and the specimen collection structure (120). The specimen collection section (220) is capable of being separated from the handle of the device. The separated specimen collection section (120) carrying the collected specimen may be, for example, transferred to a container for specimen treatment or testing of the specimen. The specimen can be treated by a means selected from a group of specimen treatments consisting of dilution with a buffer solution, centrifugation, and filtration.

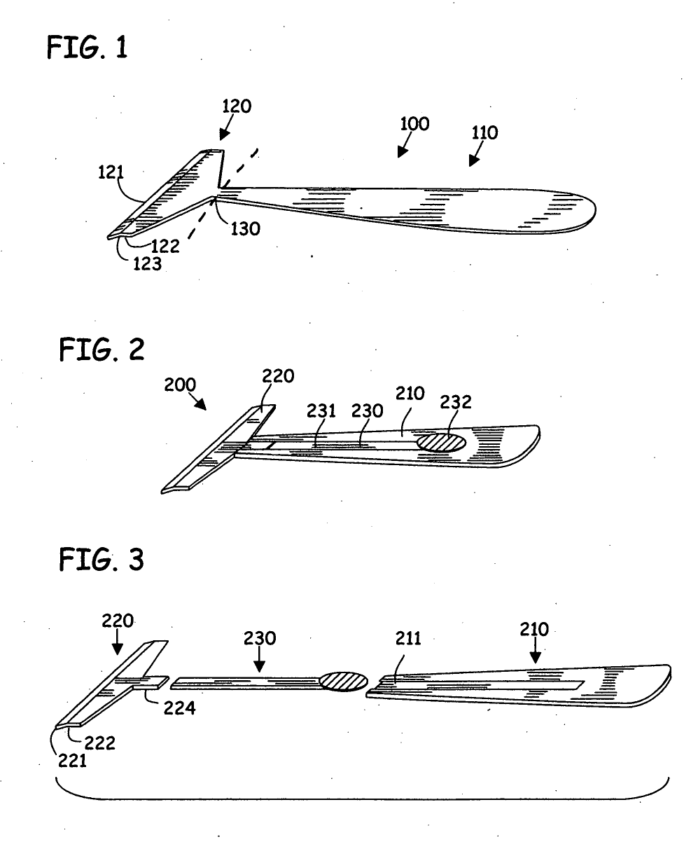

FIG. 2, in conjunction with FIG. 3, depicts another embodiment of the invention, wherein the mucus collection device comprises a handle (210) and a separate specimen collection section (220) part. The specimen collection section (220) and the handle (210) are capable of being removably connected with each other. The device further comprises a sliding ejection part (230) having a rod (231) and a push button (232). The sliding ejection part (230) and the specimen collection section (220) are fit to a slot structure (211) of the handle (210). The specimen collection section (220) is capable of being ejected from the slot (211) by sliding the ejection part (230) by pushing the push button (232) towards the specimen collection section end of the slot (211).

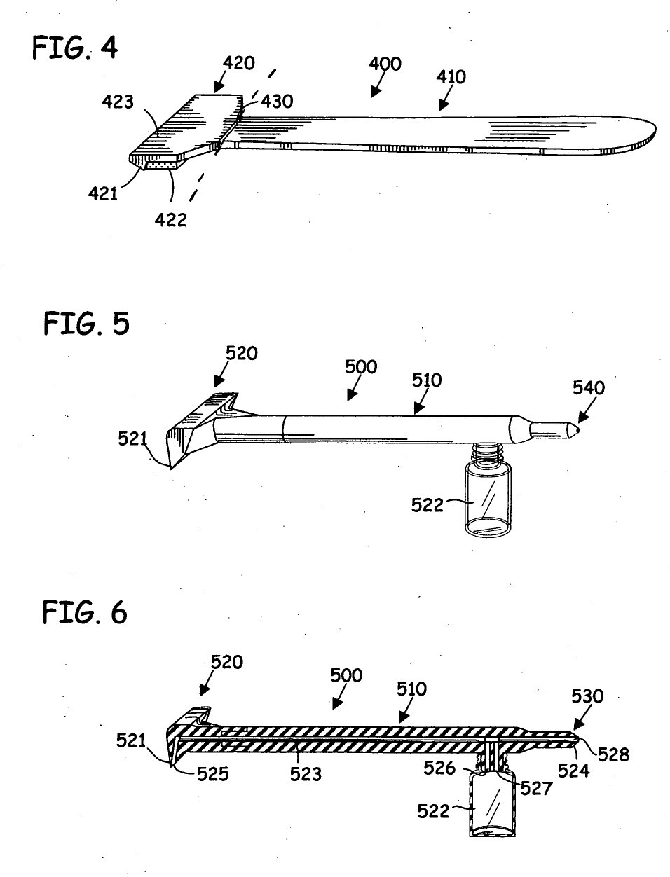

FIG. 4 depicts another embodiment of the device of the invention, which comprises a device (400) comprising a handle (410) elongated by a specimen collection section (420) having a non-absorbent scraping edge (421) and an absorptive specimen receptacle (422). The non-absorbent scraping edge (421) is capable of scraping a volume of mucus off a mucosa surface of the mouth, such as the top of the tongue, and the adjacent absorbent receptacle (422) is capable receiving the mucus specimen scraped by the non-absorptive edge (421). The absorbent structure is may be, for example, composed of a soft absorbent material, for example an inert porous material such as sponge, cellulose fiber, and cotton, for example a cotton ball, and the like. The pore size of the porous material may vary over a large range, for example, it may be between about 0.1 and about 2.5 mm. Absorbent materials of large surface area adsorb hydrophobic analytes and make the analytes inaccessible for analysis in subsequent procedures, thus small surface area absorbent materials may be, for example, selected for the absorbent structure (422). The usable mass of the absorbent structure is the portion that contacts and absorbs the mucus specimen; unusable mass of the absorbent structure should be avoided. The size of the absorbent material is may be, for example, about 0.1 cubic centimeters to about 0.5 cubic centimeters. The absorbent component is, for example, treated to render its hydrophobic surface hydrophilic, thereby reducing losses due to hydrophobicity of the analytes of interest. Such treatment methods include, but are not limited to, coating with surfactants and plasma treatment. The specimen receptacle or the specimen collection section (420) is, for example, capable of being separated from the rest of the device or utensil. Mechanisms for separating the specimen receptacle from the specimen collection section or the specimen collection section (420) from the handle (410) include, for example, breaking, removing and ejection. The exemplary device (400) of FIG. 4 may, for example, comprise a breaking line (430) for the convenience of breaking the specimen collection section (420) away from the handle (410). The separated specimen collection section (420) carrying the collected specimen may, for example, be transferred to a container for specimen treatment or testing of the specimen. The specimen can be treated by a means selected from a group of specimen treatments consisting of dilution with a buffer solution, centrifugation, and filtration.

FIG. 5, in conjunction with FIG. 6, depicts a an embodiment of the device of the invention (500) having a handle (510) elongated by a specimen collection section (520) having a non-absorbent scraping edge (521) and a specimen receptacle in the form of a reservoir (522) in fluid connection with the non-absorbent scraping edge (521) through a first vacuum tunnel (523). The reservoir (522) and the first vacuum tunnel (523) are part of a vacuum line, which further consists of a second vacuum tunnel (524). The first vacuum tunnel (523) has a first opening (525) adjacent to the non-absorbent scraping edge (521) and a second opening (526) in the reservoir (522). The second vacuum tunnel (524) consists of a first opening (527) in the reservoir (522) and a second opening (528) capable of being connected to a vacuum source. The non-absorptive scraping edge (521) is capable of scraping a volume of mucus off a mucosa surface of the mouth by an operator holding and moving the handle (510). While a vacuum is being applied at the second orifice (528) of the second vacuum tunnel (524), the scraped mucus specimen is capable of being sucked through the first opening (525) of the first vacuum tunnel (523), the first vacuum tunnel (523), and the second opening (536) of the first vacuum tunnel (523) to the reservoir (522). The specimen receptacle is optionally detachable from the handle of the device and capped for storage until the specimen is to be analyzed.

The mucus specimen collected using the device of the invention is analyzed by an analytical procedure for the detection of a drug analyte of the mouth. The analytical procedure is selected from a group including high performance liquid chromatography (HPLC), gas chromatography/mass spectrometry (GC/MS), liquid chromatography (LC), capillary electrophoresis (CE), enzyme linked immunosorbent assay (ELISA), fluorescence immunoassay (FIA), lateral flow chromatographic immunoassay, continuous flow fluorescence immunoassay, and immunochromatographic assays, which have been taught elsewhere and known to those skilled in the art.

The method for collecting a mucus specimen using the device of the invention is convenient and fast, and, therefore, is especially useful in POC testing of drugs in the mouth. The mucus-sampling device of the invention is may be, for example, included in a test kit or system, which further consists of an assay component capable of enabling an assay procedure for the detection of a drug analyte in a mucus specimen. The test kit may also include a vial, such as, for example, a dropper vial, to receive the specimen collection section, or to contain the collected mucus.

The kits of the present invention may also comprise one or more of the components in any number of separate containers, packets, tubes, vials, and the like, or the components may be combined in various combinations in such containers.

The kits of the present invention may also comprise instructions for performing one or more methods described herein and/or a description of one or more compositions or reagents described herein. Instructions and/or descriptions may be in printed form and may be included in a kit insert. A kit also may include a written description of an Internet location that provides such instructions or descriptions.

In one embodiment of the invention, the mucus-sampling device of the invention is included in a test kit for the detection of a drug analyte in the mouth comprising an assay reagent component capable of reacting with the analyte in a mucus specimen and producing an assay signal that corresponds to the presence or quantity of the analyte in the mucus specimen. The assay reagent is selected from a group of reagents capable of reacting with a drug analyte in a mucus specimen and producing an assay signal, which includes a labeled antibody, an enzyme, and an oxidation or reducing agent of the analyte.

In another embodiment of the invention, the mucus-sampling device of the invention is included in an assay system for the detection of a drug analyte in the mouth comprising a means capable of isolating and identifying the drug analyte by the molecular property of the drug, which is selected from a group including HPLC, GC/MS, LC, and CE.

### EXAMPLE

The example set forth below illustrates, but does not limit the invention. Retention of THC in the Mouth After Smoking Marijuana

0.2 grams (g) of marijuana was smoked by a test subject. Mucosal surface samples and saliva were collected at different time intervals by scraping the top side of the tongue a polypropylene card having a width×length×thickness of about 2 inches×about 3 inches×about 0.04 inches, using the about 2 inch edge of the card as an abrasive. The mucus specimens were dripped into a glass vial for further analysis. Saliva specimens were collected at the same times by directly expectorating saliva into glass vials.

The specimens were analyzed by a quantitative GC/MS method for the detection of THC.

The results of THC concentrations of the specimens are listed in Table 1.

TABLE 1
THC concentrations in saliva and in the mucosal scrapings from the top of
the tongue at different times after smoking 0.2 g of marijuana

| | THC Concentration (ng/ml) | |
|---|---|---|
| Time Post Smoking | Saliva | Mucus |

| | | |
|---|---|---|
| 5 minutes | 115 | 587 |
| 2 hours | 16 | 412 |
| 6 hours | 11 | 123 |
| 24 hours | 2.1 | 44 |

The results demonstrate that THC remains in the mucus specimen collected using the device of the invention at significantly higher concentration and for longer time than in saliva.

The entirety of each patent, patent application, publication and document referenced herein hereby is incorporated by reference in their entirety, including all tables, drawings, and figures. All patents and publications are herein incorporated by reference to the same extent as if each was specifically and individually indicated to be incorporated by reference. Citation of the above patents, patent applications, publications and documents is not an admission that any of the foregoing is pertinent prior art, nor does it constitute any admission as to the contents or date of these publications or documents. All patents and publications mentioned herein are indicative of the skill levels of those of ordinary skill in the art to which the invention pertains. Furthermore, section headers used herein are for the reader's convenience only.

Singular forms “a”, “an”, and “the” include plural reference unless the context clearly dictates otherwise. Thus, for example, reference to “a subset” includes a plurality of such subsets, reference to “a nucleic acid” includes one or more nucleic acids and equivalents thereof known to those skilled in the art, and so forth. The term “or” is not meant to be exclusive to one or the terms it designates. For example, as it is used in a phrase of the structure “A or B” may denote A alone, B alone, or both A and B.

Unless defined otherwise, all technical and scientific terms used herein have the same meanings as commonly understood by one of ordinary skill in the art to which this invention belongs. Although any methods and systems similar or equivalent to those described herein can be used in the practice or testing of the present invention, the methods, devices, and materials are now described.

Modifications may be made to the foregoing without departing from the scope, spirit and basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. One skilled in the art readily appreciates that the present invention is well adapted to carry out the objects and obtain the ends and advantages mentioned, as well as those inherent therein. The examples provided herein are representative of specific embodiments, are exemplary, and are not intended as limitations on the scope of the invention.

The invention illustratively described herein suitably may be practiced in the absence of any element(s) not specifically disclosed herein. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

What is claimed is:

1. A device for collecting a mucus specimen from a mucosal surface area of the mouth of an individual, comprising
a. a handle having a first end and a second end;
b. a specimen collection section disposed toward or releasably secured to the first end of said handle, wherein said specimen collection section has a non-absorptive scraping edge; and
c. a void adjacent to said scraping edge for containing a volume of mucus.

2. The device of claim 1, wherein said scraping edge has a about a 90 degree to about a 150 degree angle.

3. The device of claim 1, wherein said specimen collection section and said handle are releasably secured.

4. The device of claim 1, wherein said void is a slotted groove having two walls.

5. The device of claim 1, wherein said void is a receptacle for mucus.

6. The device of claim 1, wherein said void is in fluid communication with a mucus reservoir.

7. The device of claim 6, wherein said reservoir is attached to said handle.

8. The device of claim 6, wherein said reservoir is removably attached to said handle.

9. The device of claim 6, wherein said reservoir is disposed in a vacuum line connecting the scraping edge and a vacuum source.

10. The device of claim 7, wherein said reservoir is disposed in a vacuum line connecting the scraping edge and a vacuum source.

11. The device of claim 9, wherein said reservoir is removably attached to said vacuum line.

12. The device of claim 10, wherein said reservoir is removably attached to said vacuum line.

13. An assay system for the detection of at least one drug analyte in the mouth, comprising
a. a device of claim 1; and
b. an assay component capable of enabling a diagnostic testing procedure for the detection of the drug analyte in the mucus specimen.

14. The assay system of claim 13, wherein said diagnostic procedure is selected from the group consisting of high performance liquid chromatography, gas chromatography/mass spectrometry, liquid chromatography, capillary electrophoresis, and immunoassay.

15. The assay system of claim 13, wherein said assay component is selected from the group consisting of a pH buffer, a solvent for hydrophobic substances, a detergent, a preservative, and enzyme, and an antibody capable of reacting with the analyte substance

16. A kit comprising
a. a device of claim 1;
b. an assay component capable of enabling a diagnostic testing procedure for the detection of the drug analyte in the mucus specimen; and
c. instructions.

17. A method for collecting a mucus specimen from a mucosal surface area of the mouth of an individual, comprising scraping a mucosal surface area of the mouth of an individual with the non-absorbent scraping edge of the device of claim 1.

18. The method of claim 17, wherein said mucosal surface area is the tongue.

19. The method of claim 17, wherein said individual is a human.

20. The method of claim 17, wherein said individual is a human suspected of having ingested a drug.

21. The method of claim 20, wherein said drug is marijuana.

22. A method for detecting a drug analyte in the mouth of an individual, comprising collecting mucus off of a mucosal surface area of the mouth of an individual; and testing said mucus for the presence of said drug analyte.

23. The method of claim 22, wherein said mucus is collected using a non-absorbent collection material.

24. The method of claim 23, wherein said mucus is collected by scraping the mucosal surface area.

25. The method of claim 23, wherein said non-absorbent collection material has a scraping edge.

26. The method of claim 25, wherein said non-absorbent collection material is a plastic card.

27. The method of claim 23, wherein said non-absorbent collection material is a wire mesh.

28. The method of claim 22, wherein said individual is human.

29. The method of claim 22, wherein said mucosal surface area is a tongue.

30. The method of claim 22, wherein said drug analyte is THC.

31. The method of claim 23, wherein said non-absorbent collection material is connected to a void for mucus collection.

32. The method of claim 31, wherein said void is in fluid communication with a mucus reservoir.

33. A composition comprising mucus and a pH buffer, a solvent for hydrophobic substances, a detergent, a preservative, and enzyme, or an antibody capable of reacting with the analyte substance

34. The composition of claim 33, wherein said mucus is obtained by scraping a mucosal surface area of the mouth of an individual.

35. The composition of claim 34, wherein said mucus is obtained by scraping a tongue of an individual.
